(19) United States
(12) Patent Application Publication
(10) Pub. No.: US 2020/0350952 A1
(43) Pub. Date: Nov. 5, 2020

(54) NEAR FIELD SCATTERING ANTENNA CASING FOR ARBITRARY RADIATION PATTERN SYSTHESIS

(71) Applicant: The Government of the United States of America, as represented by the Secretary of the Navy, Arlington, VA (US)

(72) Inventors: Brian O. Raeker, Arlington, VA (US); Scott M. Rudolph, Washington, DC (US)

(21) Appl. No.: 16/936,327

(22) Filed: Jul. 22, 2020

Related U.S. Application Data
(63) Continuation of application No. 15/210,983, filed on Jul. 15, 2016.
(60) Provisional application No. 62/192,700, filed on Jul. 15, 2015.

(51) Int. Cl. H04B 5/00

(52) U.S. Cl. CPC H04B 5/0012; H04B 5/0081

(57) ABSTRACT

Systems and methods are disclosed for creating antenna casings, such as radomes, that can reshape the distribution of electromagnetic energy emitted by an antenna into an arbitrarily defined pattern. Embodiments of the present disclosure include antenna casings with cylindrical patterns with only azimuthal variation and antenna casings with spherical patterns having both azimuthal and elevation variations, each accomplished with an antenna casing of a fixed radial distance in the given coordinate system (either cylindrical or spherical). Antenna casings provided by embodiments of the present disclosure can alter the source radiation pattern into any desired radiation pattern at any distance.

### CROSS REFERENCE TO RELATED APPLICATIONS

This application is a continuation of U.S. patent application Ser. No. 15/210,983, filed on Jul. 15, 2016, which claims priority to U.S. Provisional Patent Application No. 62/192,700, filed on Jul. 15, 2015, both of which are incorporated by reference herein in their entireties.

### FIELD OF THE DISCLOSURE

The present disclosure relates generally to antenna casings, and more specifically relates to radomes.

### BACKGROUND

Antenna casings are commonly used to protect antennas from physical interaction with the environment. For example, traditional radomes shield antennas from rain, wind, and moving objects which could strike and harm the structure of the antenna. Conventionally, these radomes have been constructed of a dielectric material, with the goal being to minimize the effect on the radiation pattern of an antenna over the operational frequency band. This method does protect the antenna from the environment, but there are inherent costs to antenna performance in using dielectric material.

Using a dielectric radome will generally provide some insertion loss and scatter a portion of the radiated energy emitted from the antenna being protected, altering the antenna performance from expectations. Generally, the amount of power in the main lobe of the radiation pattern will decrease and the side lobe levels of the antenna will increase, changing the shape of the radiation pattern. Currently, the performance degradation caused by using a radome is outweighed by the benefits of protecting the antenna from the environment, so the degradation is tolerated.

Existing published methods addressing this issue include deforming the dielectric radome structure from the general spherical shape to cause a specific electromagnetic interaction and shape the radiated pattern, using a plurality of different dielectric elements extended from a planar antenna at the near-field boundary to approximate portions of an ideal imaginary quasi-spherical or quasi-cylindrical radome reflector, using a shaped antenna reflector to exhibit the inverse of the phase distortion of a dielectric radome to negate it, and using a cylindrical negative refractive index metamaterial lens to focus the radiated energy of a radiating element. Each of these methods requires that the antenna and radome structure be designed concurrently to achieve the desired performance, increasing the risk that design limits of one would require re-designs of the other. Additionally, the methods usually require that the shape of the radome or antenna be modified from the standard spherical or cylindrical geometry, generally limiting use of these products to new systems that can incorporate this shape change. Finally, these methods cannot form truly arbitrary radiation patterns and there is no explicit design procedure to directly synthesize these patterns.

### BRIEF DESCRIPTION OF THE DRAWINGS/FIGURES

The accompanying drawings, which are incorporated in and constitute part of the specification, illustrate embodiments of the disclosure and, together with the general description given above and the detailed descriptions of embodiments given below, serve to explain the principles of the present disclosure. In the drawings:

FIG. 1A is a diagram representing geometry of a cylindrical near-field scattering antenna casing from above in accordance with an embodiment of the present disclosure;

FIG. 1B is a diagram representing geometry of a spherical near-field scattering antenna casing with the interior visible in accordance with an embodiment of the present disclosure;

FIG. 2A is a diagram of a unit cell of an antenna casing incorporating capacitive copper traces in accordance with an embodiment of the present disclosure;

FIG. 2B is a diagram of a unit cell of an antenna casing incorporating an inductive copper trace in accordance with an embodiment of the present disclosure;

FIG. 3 is a diagram of a fabricated cylindrical near-field scattering radome placed between two conducting plates to form a parallel plate waveguide in accordance with an embodiment of the present disclosure;

FIG. 4A is a diagram of a cylindrical antenna casing, electric field magnitude pattern, and desired radiation pattern in accordance with an embodiment of the present disclosure;

FIG. 4B is a diagram of a spherical antenna casing, electric field magnitude pattern, and desired radiation pattern in accordance with an embodiment of the present disclosure; and

FIG. 5 is a method of designing an antenna casing in accordance with an embodiment of the present disclosure.

Features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

In the following description, numerous specific details are set forth to provide a thorough understanding of the disclosure. However, it will be apparent to those skilled in the art that the disclosure, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

For purposes of this discussion, the term “module” shall be understood to include one of software, or firmware, or hardware (such as circuits, microchips, processors, or devices, or any combination thereof), or any combination thereof. In addition, it will be understood that each module can include one, or more than one, component within an actual device, and each component that forms a part of the described module can function either cooperatively or independently of any other component forming a part of the module. Conversely, multiple modules described herein can represent a single component within an actual device. Further, components within a module can be in a single device or distributed among multiple devices in a wired or wireless manner.

### 1. OVERVIEW

Embodiments of the present disclosure provide systems and methods for creating antenna casings, such as radomes, that can reshape the distribution of electromagnetic energy emitted by an antenna into an arbitrarily defined pattern. Embodiments of the present disclosure include antenna casings with cylindrical patterns with only azimuthal variation and antenna casings with spherical patterns having both azimuthal and elevation variations, each accomplished with an antenna casing of a fixed radial distance in the given coordinate system (either cylindrical or spherical). While the achievable amplitude variation of the desired angular pattern is dependent on the size of the antenna casing, the near-field scattering antenna casing can enhance the radiation pattern of a given antenna rather than degrade it like a standard antenna casing will. In an embodiment, this function is achieved by fabricating designed scatterers either within or on the surface of the material constituting the antenna casing. An advantage of antenna casings provided by embodiments of the present disclosure is the ability to alter the source radiation pattern into any desired radiation pattern at any distance.

### 2. NEAR FIELD SCATTERING ANTENNA CASING FOR ARBITRARY RADIATION PATTERN SYNTHESIS

Embodiments of the present disclosure provide a near-field scattering antenna casing (e.g., a radome) that is designed to re-shape the radiated electromagnetic energy pattern of any given antenna through the addition of sub-wavelength scatterers to an existing antenna casing (e.g., radome) shape, either within the volume or at the surface of the antenna casing. These designed subwavelength scatterers, termed electromagnetic metamaterials or metasurfaces, exhibit tailored electromagnetic responses that can be beyond the abilities of traditionally used materials.

Embodiments of the present disclosure include antenna casings in cylindrical and spherical shapes. In an embodiment, the shape of the antenna casing is determined by the application as well as the source antenna. If the radiation pattern is required to change in azimuth and elevation, a spherical antenna casing can be used since a cylindrical antenna casing is limited to only providing azimuthal radiation pattern variation. Otherwise, if the radiation pattern is only desired in the azimuth, a cylindrical antenna casing can be used, as it is simpler to construct.

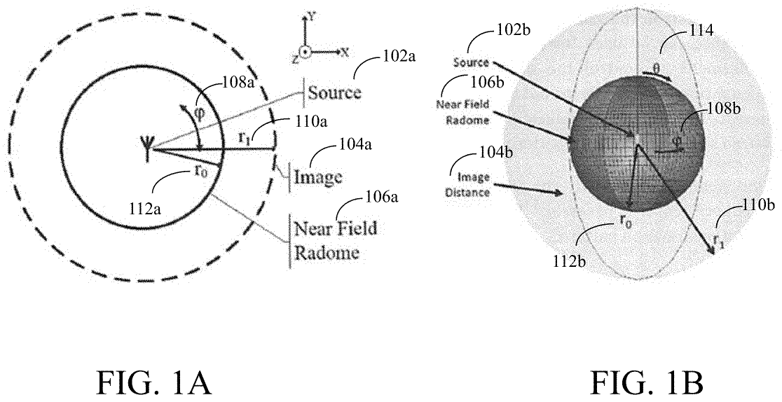

FIG. 1A is a diagram representing geometry of a cylindrical near-field scattering antenna casing (in this case, a radome) from above in accordance with an embodiment of the present disclosure. In FIG. 1A, the source antenna 102a is located at the center of the cylinder, with the radome structure a constant distance away. In FIG. 1A, r₀ 112a is the radial distance to the radome 106a, r₁ 110a is the distance to the image pattern 104a, and φ 108a is the azimuthal angle from the x-axis.

FIG. 1B is a diagram representing geometry of a spherical near-field scattering antenna casing (in this case, a spherical radome) with the interior visible in accordance with an embodiment of the present disclosure. The geometry of the spherical antenna casing of FIG. 1B is similar to the geometry of the cylindrical antenna casing of FIG. 1A. In FIG. 1B, r₀ 112b is the radial distance from the source 102b to the radome 106b, r₁ 110b is the radial distance to the image pattern 104b, θ 114 is the elevation angle, and φ 108b is the azimuthal angle.

The metamaterial included in an antenna casing in accordance with an embodiment of the present disclosure (e.g., radomes shown in FIG. 1A and FIG. 1B) provides the ability to reshape the radiated pattern to be one of any desired shape. For example, near-field plates are capable of reshaping an electromagnetic plane wave into a desired focus by patterning a surface with metallic traces to realize a specific effective surface impedance value. The collection of impedance scatterers creates a scattered electric field such that when added to the incident electric field of the source, the result is the desired focus pattern.

In an embodiment, the antenna casings (e.g., radomes) of FIG. 1A and FIG. 1B can include a plurality of metamaterial structures. In an embodiment, the metamaterial structures are patterned at a sub-wavelength scale. Each metamaterial structure can be smaller than a tenth of the wavelength of the desired frequency. At this size, there are potentially thousands of small metamaterial structures, which can be referred to as unit cells, at the surface of or within the cylindrical or spherical antenna casing (e.g., radome). While a better resolution of the desired image pattern can be achieved with a larger antenna casing radius, the number of unit cells will drastically increase as well, so a balance between desired resolution and complexity should ideally be reached.

In an embodiment, the method used to create the desired radiation pattern first decomposes the desired field in terms of its Fourier or Fourier-Legendre components. These components are then reverse-propagated to the surface of the antenna casing (e.g., radome). This procedure determines the field that is to be scattered by the near-field scattering radome, which in turn, uniquely determines the surface impedance required to scatter the incident field appropriately. By creating the reverse-propagated electric field pattern at the surface of the radome, the desired radiation pattern will appear at the specified distance as it radiates outwards. Using this method, the resulting radiation pattern is realized to be nearly exactly as desired within the limits of the Fourier or Fourier-Legendre modes that can be excited at the surface of the radome.

To determine the surface impedance values required to create the required scattered electric field to sum with the source electric field and create the desired radiation pattern, a series of calculations are performed. To alter an electric field pattern with a specific polarization, the surface impedance should have the required value in the same direction as the polarization. From this reasoning, an isotropic surface impedance can be used for pattern control of a single electric field polarization if there is no requirement to control the other polarization. Alternatively, a diagonal anisotropic surface impedance tensor can be used if the desired impedance is exhibited in the polarization direction of interest. The impedance values in the other direction would be inconsequential since there is no desired surface impedance pattern in that direction.

If independent image patterns are required for each polarization, a diagonal anisotropic surface impedance tensor is necessary. The surface impedance must be calculated independently for each desired polarization pattern. The resulting impedance values are a combination of resistance and capacitive or inductive values, which can be implemented through thin copper traces and resistive material at the surface of the radome. An example of resistive material is Nickel Phosphorous.

### 2.1 Unit Cell

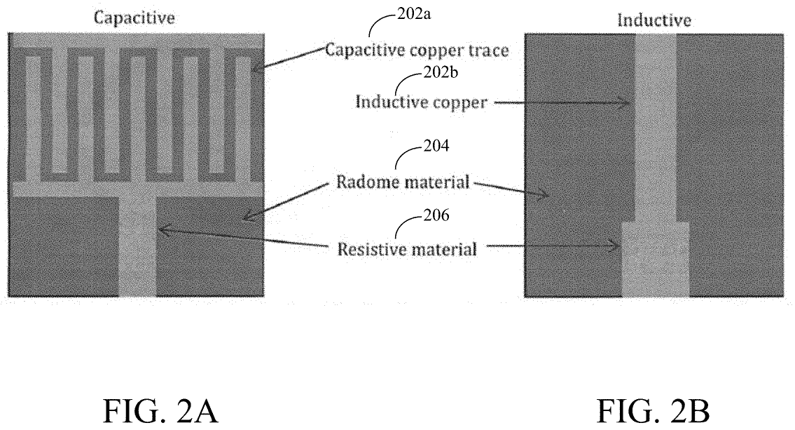

FIGS. 2A and 2B show examples of how the surface impedance can be implemented for the required values to implement a radiation pattern in a single polarization. Since a radiation pattern was being imposed on only one polarization, these unit cells were designed to exhibit the desired impedance in the vertical direction without any consideration for the impedance in the horizontal direction.

FIG. 2A is a diagram of a unit cell of an antenna casing incorporating capacitive copper traces in accordance with an embodiment of the present disclosure. The unit cell of FIG. 2A includes capacitive copper traces 202a radome material 204, and resistive material 206. FIG. 2B is a diagram of a unit cell of an antenna casing incorporating an inductive copper trace in accordance with an embodiment of the present disclosure. The unit cell of FIG. 2B includes an inductive copper trace 202b, radome material 204, and resistive material 206.

In an embodiment, the impedance unit cells of FIGS. 2A and 2B are oriented in the same direction as the electric field vector, which is vertical in the case of FIGS. 2A and 2B. To form a continuous surface, the unit cells are oriented next to each other in such a way that the cylindrical or spherical antenna casing shape is formed.

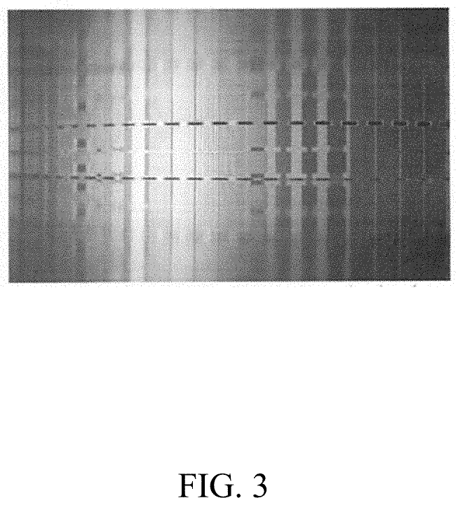

FIG. 3 is a diagram of a fabricated cylindrical near-field scattering radome placed between two conducting plates to form a parallel plate waveguide in accordance with an embodiment of the present disclosure. FIG. 3 shows a two unit cell high fabricated cylindrical near-field scattering radome in between two conducting planes forming a parallel plate waveguide. The design for this radome re-directs the isotropic radiation pattern of a current line source to only radiate in a 180 degree beamwidth in the azimuth.

In an embodiment, the unit cells of an antenna casing in accordance with an embodiment of the present disclosure can be implemented as a continuous sheet (e.g., as shown in FIG. 3). In an embodiment, each cell in the sheet depends on all other cells, and the size, orientation, and/or shape of each unit cell affects each other unit cell.

### 2.2 Radiation Patterns

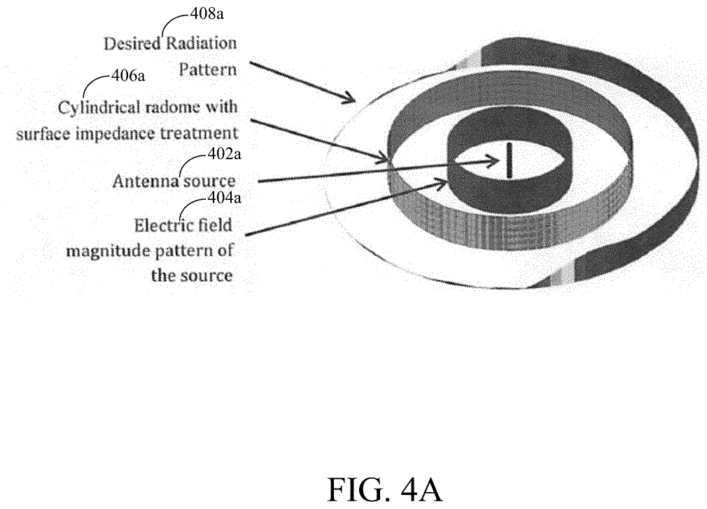

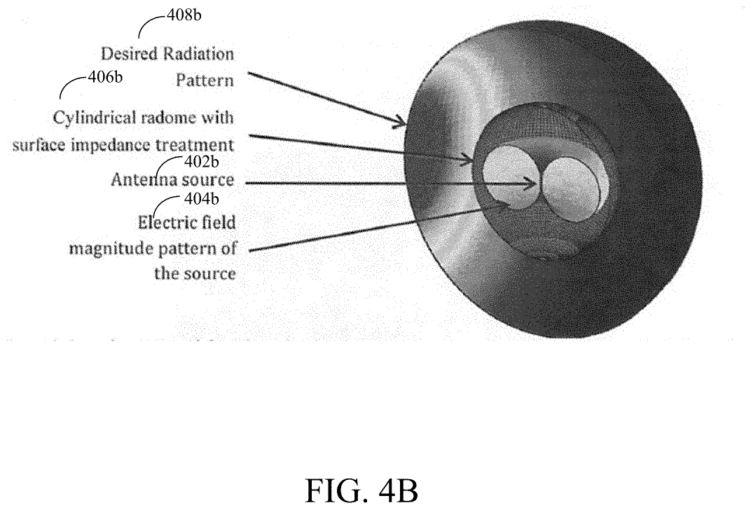

FIGS. 4A and 4B show diagrams of cylindrical and spherical antenna casings (e.g., radomes) and corresponding electric field magnitude pattern and desired radiation pattern in accordance with embodiments of the present disclosure. FIG. 4A is a diagram of a cylindrical antenna casing (e.g., radome) 406a around antenna source 402a having electric field magnitude pattern 404a. FIG. 4A shows the desired radiation pattern 408a in accordance with an embodiment of the present disclosure. FIG. 4A shows the ability of cylindrical antenna casing 406a to reshape the radiation pattern of source 402a. The required surface impedance is implemented on the surface of cylindrical antenna casing 406a, reshaping the isotropic pattern of a line current source into a more directive pattern.

FIG. 4B is a diagram of a spherical antenna casing (e.g., radome) 406b around antenna source 402b having electric field magnitude pattern 404b. FIG. 4B shows the desired radiation pattern 408b in accordance with an embodiment of the present disclosure. FIG. 4B shows how spherical antenna casing 406b transforms the radiated pattern from a dipole into a Gaussian shaped radiated pattern.

While the cylindrical antenna casing of FIG. 4A is limited in altering the pattern with only azimuthal variation, the spherical antenna casing of FIG. 4B can form a pattern in both elevation and azimuth. FIG. 4B shows an example of the ability of the spherical antenna casing 406b to reshape the radiated pattern in the azimuthal and elevation angle.

### 2.3 Method of Designing an Antenna Casing

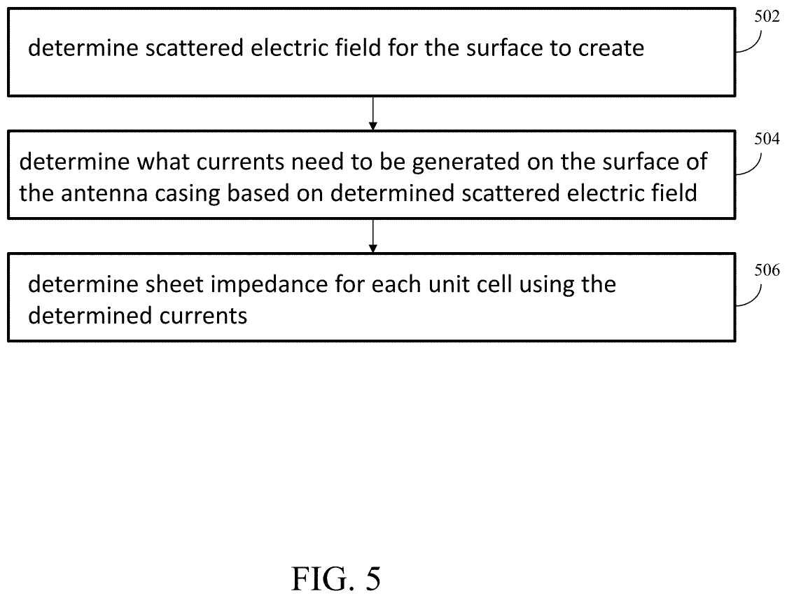

A method of designing an antenna casing in accordance with an embodiment of the present disclosure will now be described with respect to FIG. 5. First, a desired incident pattern (i.e., image pattern) and a source electric field of radiation from the antenna are received and/or known. The antenna casing (e.g., radome) can then be designed given these known parameters.

In step 502, the scattered electric field for the surface to create is determined. For example, for a cylindrical antenna casing embodiment, the first step in determining the electric field at the antenna casing required to produce the desired image pattern is to decompose the electric field at the image radius into its corresponding spatial harmonics. In an embodiment, the desired electric field image pattern can be expressed as a Fourier series to provide the sinusoidal components and coefficients. The radially dependent terms of all outward propagating cylindrical wave harmonics can be described by Hankel functions of the second kind of the same order as the mode of the azimuthal component. These functions can be used to synthesize a desired far field pattern.

For a spherical antenna casing embodiment, the first step in determining the electric field at the antenna casing required to produce the desired image pattern is to decompose the desired electric field function at the image into its corresponding modes of free space. Since the desired spherical image pattern at a specified radial distance is a function over the surface of the sphere, the elevation and azimuthal variations can be easily expressed using a Fourier-Legendre series. The radially dependent terms of all outward propagating spherical waves can be described by spherical Hankel functions of the second kind of the same order as the mode number. These functions can be used to synthesize a desired far-field pattern.

In step 504, the determined scattered electric field from step 502 is used to determine what currents need to be generated on the surface of the antenna casing. For example, in an embodiment, these currents can be determined using method of moments process for surfaces of arbitrary shapes. In an embodiment, the currents are designed to cancel out the source field from the antenna in a direction that is desired to be nulled.

In step 506, sheet impedance for each unit cell can be determined using the determined currents from step 504. For example, the surface of the antenna casing can be discretized into flat patches e.g., triangular patches), and a mutual impedance matrix can be calculated. The current density and desired electric field at the antenna casing are converted to spherical vector representation and used to calculate the required surface impedance of the antenna casing.

Next, the physical geometry of each cell can be determined based on the determined sheet impedance from step 506. For example, with the surface impedance values known for each face of the antenna casing based on the method of moments calculation, metamaterial unit cells can be designed to exhibit these impedances at a specified frequency.

### 2.4 Cylindrical Antenna Casing Design

A procedure for designing a cylindrical antenna casing will now be described in greater detail. As discussed above in section 2.3, based on a known desired incident pattern (i.e., image pattern) and a source electric field of radiation from the antenna, the antenna casing (e.g., radome) can then be designed given these known parameters.

In step 502, the scattered electric field for the surface to create is determined. For example, for a cylindrical antenna casing embodiment, the first step in determining the electric field at the antenna casing required to produce the desired image pattern is to decompose the electric field at the image into its corresponding spatial harmonics, taking the form:

$${E}_{derived} ( r , θ ) = C {\sum }_{n} {R}_{n} ( r ) {Θ}_{n} ( θ ) . \qquad ( 1 )$$

Θₙ(θ) represents the n^{th} azimuthal component of the image pattern. Rₙ(r) represents the nth radially propagating component of the image pattern electric field and is used to reverse propagate the electric field to the surface of the shell. The variable C is a complex scalar constant and z-dependence has been omitted since this design has no z variation.

The desired electric field image pattern is easily expressed as a Fourier series to provide the sinusoidal components and coefficients. Θₙ(θ) then takes the form

$${Θ}_{n} ( θ ) = \{ \begin{matrix}\frac{{a}_{0}}{2} & n = 0 \\ {a}_{n} cos ( n θ ) + {b}_{n} sin ( n θ ) & n > 0.\end{matrix} \qquad ( 2 )$$

The radially dependent terms of all outward propagating cylindrical wave harmonics are described by Hankel functions of the second kind of the same order as the mode of the azimuthal component. Therefore, the radial component is

$${R}_{n} ( r ) = \frac{{H}_{n}^{( 2 )} ( kr )}{{H}_{n}^{( 2 )} ( {kr}_{1} )} \qquad ( 3 )$$

Note that dividing by Hₙ⁽²⁾(kr₁) normalizes the wave harmonic amplitudes to construct the desired azimuthal dependence at the image. Substituting (2) and (3) into (1) provides the complete harmonic series of the desired electric field:

$${E}_{desired} ( r , θ ) = {e}^{j α} {M}_{0} {E}_{0} [ \frac{{H}_{0}^{( 2 )} ( kr )}{{H}_{0}^{( 2 )} ( {kr}_{1} )} \frac{{a}_{0}}{2} + {\sum }_{n = 1}^{∞} \frac{{H}_{n}^{( 2 )} ( kr )}{{H}_{n}^{( 2 )} ( {kr}_{1} )} ( {a}_{n} cos ( n θ ) + {b}_{n} sin ( n θ ) ) ] \qquad ( 4 )$$

Here, e^{iα} provides a phase change to control how reactive the resulting surface impedance of the shell is, M₀ is a constant scalar multiplier, E₀ is the maximum amplitude of the incident field at the image distance, r₁ is the image distance, and a₀, aₙ, and bₙ are the Fourier coefficients from (2). At r₁, (4) will provide the azimuthal pattern specified in (2) scaled by e^{iα}M₀E₀. When the image distance approaches infinity, the behavior of 1/Hₙ⁽²⁾(kr₁) simplifies to (5).

$$\frac{1}{{H}_{n}^{( 2 )} ( {kr}_{1} )} \vec{{r}_{1} \to ∞} \sqrt{\frac{π {kr}_{1}}{2 j}} {j}^{- n} {e}^{{jkr}_{1}} \qquad ( 5 )$$

This simplification leads to the far-field version of (4), giving

$${E}_{desired} ( r , θ ) = {e}^{j ( {α}^{′} )} {M}_{0}^{′} [ {H}_{0}^{( 2 )} ( kr ) \frac{{a}_{0}}{2} + {\sum }_{n = 1}^{∞} {j}^{- n} {H}_{n}^{( 2 )} ( kr ) ( {a}_{n} cos ( n θ ) + {b}_{n} sin ( n θ ) ) ] \qquad ( 6 )$$

This equation can be used to synthesize a desired farfield pattern. Since E₀ is proportional to \sqrt{1/kr}, it will cancel \sqrt{kr₁} and the scaled and phase-changed version of the Fourier series becomes the desired radiation pattern. Any residual amplitude and phase changes from this approximation are absorbed into M′₀ and α′.

While an infinite number of harmonics are required to perfectly represent the desired azimuthal pattern at the image distance, only a finite number can be accurately be used with the chosen radial distance of the antenna casing. The form of (4) suggests that the electric field of each harmonic is emanating from an equivalent line source at the origin. With this observation, successively higher harmonics can be thought of as having a reactive near-field, represented by the dominant 1/kr form of the imaginary component of H₍ₙ₎²(kr), which extends farther in the radial direction with increasing order n. When this equivalent reactive near field dominates the magnitude of the harmonic at the near-field shell boundary it will also dominate the total electric field summation in (4) since it will be much larger than the magnitudes of the lower harmonics. The surface impedance calculation is then overtaken by the higher order harmonics making it difficult to resolve the differences attributable to the lower orders, making it desirable to truncate the summation.

To determine where to truncate the series, the magnitudes of the different order Hankel functions at the surface of the near-field shell can be compared. The order at which the 1/kr characteristic begins to dominate the magnitude of the Hankel function can be determined and all higher harmonics excluded. From qualitative observations, the 1/kr characteristic begins to dominate the magnitude of the Hankel function when n>kr. This is not a hard limit, but if n>>kr the higher order harmonics will dominate the field at the shell while contributing much less significantly to the field at the image.

Once (4) is expressed with the desired number of harmonics, each mode is reverse propagated to determine the desired electric field at the surface of the antenna casing. This is done by setting r=r₀. The required electric field scattered by the shell is then found by subtracting the desired electric field from the incident electric field at the surface of the shell, shown by

E_{scattered}(r₀,θ)=E_{incident}(r₀,θ)−E_{desired}(r₀,θ) (7)

The scattered electric field from a vertically polarize electric field incident on a cylinder is given by the integral

$${E}_{scattered} = \frac{k η}{4} {\int }_{- π}^{π} {J}_{z} ( {θ}^{′} ) {H}_{0}^{( 2 )} ( {kr}_{0} \sqrt{2 ( 1 - cos ( θ - {θ}^{′} ) )} ) {r}_{0} d {θ}^{′} \qquad ( 8 )$$

This integral cannot be solved analytically, so the method of moments is used to discretize the integral into a matrix equation. (7) then becomes a matrix equation consisting of the impedance matrix [Z], which is purely dependent on the geometry of the shell, and the discrete surface current matrix [L], which is unknown.

Use of the method of moments results in the discretization of the surface of the antenna casing into an integer amount of unit cells of a sub-wavelength width and therefore a discrete surface current distribution. The discretization is such that the widths of each unit cell are λ/10 or smaller. The relationship between the incident electric field, the desired electric field, and the impedance matrix is given by [E_{desired}]=[E_{incident}]−[Z][J_{z}]. Rearranging this equation allows the discrete surface current distribution to be solved for. The surface impedance is then calculated using

$${Z}_{sheet} ( i ) = \frac{{E}_{desired} ( i )}{{J}_{z} ( i )} .$$

The surface impedance of cell i is the ratio of the desired field at the surface of the shell and the surface current of the unit cell. Note that Zₛₕₑₑₜ(i) is the actual surface impedance of the shell which depends on the incident and desired electric fields. As a result, Zₛₕₑₑₜ(i) cannot be found directly from the impedance matrix, [Z]. To implement the antenna casing, the unit cell structures can be designed such that the required surface impedances are realized at a specified design frequency.

### 2.5 Spherical Antenna Casing Design

A procedure for designing a spherical antenna casing will now be described in greater detail. As discussed above in section 2.3, based on a known desired incident pattern (i.e., image pattern) and a source electric field of radiation from the antenna, the antenna casing (e.g., radome) can then be designed given these known parameters.

For a spherical embodiment, since the source antenna is completely enclosed, the antenna casing can control the image pattern of a specific electric field polarization in both the azimuth and elevation. Also, since the electric field of a specific polarization is altered by current densities in the same direction and the surface impedance will allow currents to be induced, the surface impedance must have the required value in the same direction as the polarization. From this reasoning, an isotropic surface impedance can be used for pattern control of a single electric field polarization if there is no requirement to control the other polarization. Otherwise, if independent image patterns are required for each polarization, a diagonal anisotropic surface impedance is necessary. The surface impedance values of the antenna casing are found from calculations involving the desired image pattern and the incident source electric field and should be calculated independently for each desired polarization pattern.

For equations shown below, the following terms are introduced:

$$\begin{matrix} {a}_{0 n} = \frac{2 n + 1}{4 π} {\int }_{0}^{2 π} d φ {\int }_{0}^{π} f ( θ , φ ) {P}_{n}^{0} ( cos ( θ ) ) d θ & ( 9 ) \\ {a}_{mn} = \frac{2 n + 1}{2 π} \frac{( n - m ) !}{( n + m ) !} {\int }_{0}^{2 π} d φ {\int }_{0}^{π} f ( θ , φ ) {P}_{n}^{m} ( cos ( θ ) ) cos ( m φ ) sin ( θ ) d θ & ( 10 ) \\ {b}_{mn} = \frac{2 n + 1}{2 π} \frac{( n - m ) !}{( n + m ) !} {\int }_{0}^{2 π} d φ {\int }_{0}^{π} f ( θ , φ ) {P}_{n}^{m} ( cos ( θ ) ) sin ( m φ ) sin ( θ ) d θ & ( 11 ) \\ {E}_{desired} ( r , θ , φ ) = {e}^{j α} {M}_{0} {E}_{0} [ {\sum }_{n = 1}^{∞} {\sum }_{m = 1}^{n} \frac{{h}_{n}^{( 2 )} ( kr )}{{h}_{n}^{( 2 )} ( {kr}_{1} )} {P}_{n}^{m} ( cos ( θ ) ) [ {a}_{mn} cos ( m φ ) + {b}_{mn} sin ( m φ ) ] ] & ( 12 ) \\ {E}_{far \text{-} field} ( r , θ , φ ) = {e}^{j {α}^{′}} {M}_{0}^{′} [ {\sum }_{n = 1}^{∞} {\sum }_{m = 1}^{n} {j}^{- ( n + 1 )} {h}_{n}^{( 2 )} ( kr ) {P}_{n}^{m} ( cos ( θ ) ) [ {a}_{mn} cos ( m φ ) + {b}_{mn} sin ( m φ ) ] ] & ( 13 )\end{matrix}$$

For a spherical antenna casing embodiment, the first step in determining the required electric field from the specified image pattern is to decompose the desired electric field function at the image into its corresponding modes of free space, taking the form

$${E}_{desired} ( r , θ , φ ) = C {\sum }_{n = 1}^{∞} {\sum }_{m = 1}^{n} {R}_{n} ( r ) {Θ}_{mn} ( θ ) {Φ}_{mn} ( φ ) . \qquad ( 14 )$$

Rₙ(r) represents the radially propagating behavior of the image pattern electric field and is used to reverse propagate the electric field to the surface of the shell. Θₘₙ(θ) and Φₘₙ(ϕ) represent the variation of the pattern with respect to the elevation and azimuthal angles, respectively. The variable C is a constant scalar.

Since the desired spherical image pattern at a specified radial distance is a function over the surface of a sphere, the elevation and azimuthal variations can be easily expressed using a Fourier-Legendre series. The Fourier-Legendre series should be derived from a normalized function, allowing scaling coefficients to separately set the overall magnitude of the image pattern. The elevation variation is represented by the associated Legendre polynomial of cos(θ), shown by

Θₘₙ(θ)=Pₙₘ(cos(θ)) (15)

The azimuthal variation is given as

Φₘₙ(ϕ)=aₘₙ cos(mϕ)+bₘₙ sin(mϕ) (16)

Equation (16) is similar to a Fourier series except that the coefficients also depend on the elevation angle behavior. The coefficients, aₘₙ and bₙₘ, are calculated using (9)-(11), where the desired normalized image pattern is designated as f(θ, ϕ). The radially dependent terms of all outward propagating spherical waves are described by spherical Hankel functions of the second kind of the same order as the mode number n. Therefore, the radial behavior is determined to be

$${R}_{n} ( r ) = \frac{{h}_{n}^{( 2 )} ( kr )}{{h}_{n}^{( 2 )} ( {kr}_{1} )} \qquad ( 17 )$$

Note that dividing by hₙ⁽²⁾(kr₁) normalizes the radial behavior amplitude such that only the angular behavior is seen at the image distance. Substituting (15), (16), and (17) into (14) provides the complete mode summation of the desired electric field, shown in (12). In (12), e^{jα} provides a phase change to control how reactive the resulting surface impedance of the shell is, M₀ is a scalar multiplier, E₀ is the maximum magnitude of the incident field at the image distance to provide order of magnitude similarity, k is the wavenumber, r is the radial distance, and r₁ is the image distance. At the image distance, (12) will provide the image pattern, f(θ, ϕ), scaled by e^{jα}M₀E₀.

When the image distance approaches infinity, the behavior of 1/hₙ⁽²⁾(kr₁) simplifies to

$$\frac{1}{{h}_{n}^{( 2 )} ( {kr}_{1} )} \vec{{r}_{1} \to ∞} {j}^{- ( n + 1 )} {kr}_{1} {e}^{{jkr}_{1}} \qquad ( 18 )$$

This simplification leads to the far-field version of (12), resulting in the relation shown in (13) and can be used to synthesize a desired far-field pattern. Since E₀ is proportional to 1/kr₁, it will cancel kr₁ and the scaled and phase changed version of the summation becomes the desired radiation pattern. Any residual amplitude and phase changes from this approximation are absorbed into M′₀ and α′.

For more complex spherical image patterns, higher modes of n are needed to reach the required resolution. While these higher mode patterns can be created at the surface of the shell at any radius, they may quickly attenuate during propagation since their evanescent regions can extend radially further than the surface of the antenna casing. The evanescent region for each mode n is given by 0≤r≤n/k. This boundary is approximate, but it does suggest that an appropriate radius of the antenna casing should be r₀≥N/k, where N is the highest order harmonic included in the Fourier-Legendre series.

Once the desired electric field at the image is constructed, each mode is reverse propagated to the surface of the antenna casing by simply setting r=r₀. The electric field required to be scattered by the antenna casing is then calculated by subtracting the desired electric field from the incident source electric field at the surface of the shell, shown by

E_{scattered}(r₀,θ,ϕ)=E_{incident}(r₀,θ,ϕ) (19)

The next step in the process is to solve for the surface currents required to generate the necessary scattered electric field from the antenna casing. In an embodiment, this is done using the method of moments process for surfaces of arbitrary shapes. A number of steps must be completed to set up the method of moments calculation, the first is to discretize the surface of the spherical antenna casing into flat (e.g., triangular) patches. The triangular patches should have dimensions smaller than λ/10, satisfying the metamaterials approach being used.

Once the triangular patch model is defined, the mutual impedance matrix [Z] can be calculated since it is purely dependent on the geometry of the antenna casing. The method of moments mutual impedance matrix is different from the surface impedance distribution of the antenna casing, which requires further calculations to derive. With [Z] known, the complex surface current magnitudes over each edge of the patch model, [J], are determined by using the calculated values of E_{scattered}(r₀,θ,ϕ).

The resulting matrix of complex current density values represents the current densities perpendicular over each edge of the triangular faces constituting the spherical model. To determine the current density vector at the center of the triangular face, the current magnitudes from each edge can be converted to vector form and averaged. The current density and desired electric field at the shell are converted to spherical vector representation and used with (20) to calculate the required surface impedance of the spherical antenna casing to control the desired electric field polarization. This ratio, calculated separately for each electric field polarization, results in the surface impedance in the same vector direction as the electric field polarization for each triangular face, indexed by i.

$${Z}_{sheet} ( i ) = \frac{{E}_{desired} ( i )}{J ( i )} \qquad ( 20 )$$

With the surface impedance values known for each triangular face, metamaterial unit cells can be designed to exhibit these impedances at a specified frequency. For example, printed circuit board metallic and resistive material traces can be used to exhibit the desired surface impedance.

### 3. ADVANTAGES

In addition to providing the physical protection of a standard antenna casing, embodiments of the present disclosure are capable of altering the source radiation pattern into any desired radiation pattern at any distance. Other methods can only slightly alter the radiation pattern of the given antenna. To our knowledge, no other system, device, or process is currently capable of forming a truly arbitrary radiation pattern.

Other radome augmentation systems have focused on only individually negating the detrimental effects of using a radome, which include higher sidelobe levels, lower directivity, and the distortion of the propagating phase front. Methods to counteract these effects include: deforming the dielectric from the general spherical shape to control scattering, using different dielectric blocks to approximate ideal reflector areas of a cylindrical or spherical radome, shaping an antenna reflector dish to exhibit the inverse of the phase change induced by the radome material to counteract it, and using a negative refractive index material lens to focus the radiated energy of a given antenna. Each of these methods involves either changing the overall shape of the radome, or changing the antenna in an attempt to negate the detrimental effects of the radome.

Since embodiments of the present disclosure use a cylindrical or spherical antenna casing (e.g., radome) and the existing antenna to control the radiation pattern, the antenna casing in accordance with an embodiment of the present disclosure could be easily substituted into existing systems, unlike antenna casings of earlier methods. In an embodiment, an antenna casing in accordance with an embodiment of the present disclosure will also only have electrical components that are sealed within or at the surface of the antenna casing, protecting the sensitive components from the exterior environment. Additionally, embodiments of the present disclosure can completely reshape the radiation pattern of the antenna, while the previously mentioned methods cannot.

Embodiments of the present disclosure provide the ability to change the radiated field of any source into any arbitrary radiation pattern at any distance (near field or far field), but within the resolution of the diffraction limit. The ability to realize completely arbitrary radiation patterns from any existing source has not been demonstrated before. Furthermore, the radiation patterns that can be realized are complete 4π steradian patterns, not just the shape and orientation of the main beam. Previous methods of synthesizing arbitrary patterns for (leaky wave) antennas cannot be used to alter the performance of existing antennas. Additionally, the leaky-wave antennas can only design arbitrary far-field patterns. Embodiments of the present disclosure can synthesize field patterns in either the near field or the far field.

Embodiments of the present disclosure provide a complete design procedure that can be implemented as long as the field pattern of the source antenna and the desired field pattern at the image radius are known. Embodiments of the present disclosure have several applications, including eliminating side lobes of a radiation pattern to increase isolation with nearby antennas, adding null regions to a radiation pattern so that antennas can be placed in close proximity, and producing custom radiation patterns for very specific purposes which are difficult for conventional antennas to satisfy.

### 4. ALTERNATIVES

While impedance surface treatment is the metamaterial discussed above used to verify the desired performance of re-shaping a radiated energy pattern, it should be understood that other methods are expected to work as well. For example, a specific electric field distribution can be created at the surface of the radome to act as the source for the desired radiation pattern. This is a natural point of interrupting the existing design process to substitute in a different metamaterial structure.

In an embodiment, the current surface treatment method is only capable of controlling the electric field of the electromagnetic wave, causing reflections to occur at the radome where radiation is not desired. By adding a finite thickness to the surface, control over the magnetic field can be achieved. This modification to the metamaterial structure will allow for reflectionless control over electromagnetic waves. This would allow “subtraction” of undesirable regions of a radiation pattern independent of the source within the radome.

In an embodiment, surface impedance layers can be placed radially such that each layer only slightly alters the radiated pattern. With enough layers, the complete change in radiation pattern would be achieved. The goal of only gradually changing the radiation pattern is to improve the bandwidth of operation and reduce the reliance on large reflections to redirect energy.

Another metamaterial structure that could be used would be a volumetric metamaterial, where the unit cells have a depth instead of being flat. This geometry can benefit from established advances in metamaterials so that the electromagnetic response over frequency can be designed as required. Additionally, using this type of metamaterial structure could allow active control over the radiation pattern, both in changing the direction and amplitude of radiation in result to external stimuli.

### 5. APPLICATIONS

There are numerous uses for this technology in both the military and commercial sectors. The basic implementation of reshaping the antenna pattern would allow for the installation of new antennas in prime locations, such a communication towers or ship masts. By introducing nulls in the radiation pattern of both the new antenna as well as previously installed antennas, the new antenna can operate without interference from and without interfering with those antennas already installed on the platform.

More fundamentally, this procedure allows any antenna pattern to be directly synthesized, provided the pattern is realizable within the limits of diffraction theory. Near-field scattering radomes could be used to provide any desired field pattern without the expense and time of a long design process. Additionally, these radomes could be used to enhance the properties of functional antennas; allowing them to exhibit decreased sidelobe levels, higher directivity or more rapid cutoff outside the main beam.

By giving the unit cells the capability to dynamically tune their impedance, the radome could also be used to produce nulls in the direction of jamming signals in the case of radar or communication systems. This would allow these systems to continue functioning in the presence of jamming with only a slight reduction in performance.

Other implementations of this technology could be useful in the medical field. Transcranial magnetic stimulation uses focused magnetic fields to stimulate neurons in the brain. The near-field scattering radome could allow for improved focusing of the electromagnetic waves as well as a reconfigurable field pattern using the dynamic impedance tuning mentioned above. The improved control would reduce the risk of accidently stimulating unintended regions of the brain. The dynamic impedance tuning would enable different regions to be stimulated rapidly, allowing for improved identification of the critical neurons.

### 6. CONCLUSION

It is to be appreciated that the Detailed Description, and not the Abstract, is intended to be used to interpret the claims. The Abstract may set forth one or more but not all exemplary embodiments of the present disclosure as contemplated by the inventor(s), and thus, is not intended to limit the present disclosure and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

Any representative signal processing functions described herein can be implemented using computer processors, computer logic, application specific integrated circuits (ASIC), digital signal processors, etc., as will be understood by those skilled in the art based on the discussion given herein. Accordingly, any processor that performs the signal processing functions described herein is within the scope and spirit of the present disclosure.

The above systems and methods may be implemented as a computer program executing on a machine, as a computer program product, or as a tangible and/or non-transitory computer-readable medium having stored instructions. For example, the functions described herein could be embodied by computer program instructions that are executed by a computer processor or any one of the hardware devices listed above. The computer program instructions cause the processor to perform the signal processing functions described herein. The computer program instructions (e.g., software) can be stored in a tangible non-transitory computer usable medium, computer program medium, or any storage medium that can be accessed by a computer or processor. Such media include a memory device such as a RAM or ROM, or other type of computer storage medium such as a computer disk or CD ROM. Accordingly, any tangible non-transitory computer storage medium having computer program code that cause a processor to perform the signal processing functions described herein are within the scope and spirit of the present disclosure.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments.

What is claimed is:

1. A method for designing an antenna casing for an antenna based on a desired electric field for radiation, the method comprising:
determining a desired scattered electric field to be created by the antenna casing, wherein the desired scattered field is equal to a desired incident electric field to be generated by the antenna minus the desired electric field;
determining, based on the determined desired scattered electric field, a plurality of desired currents for unit cells of the antenna casing;
discretizing, based on a geometry of the antenna casing and the plurality of desired currents, the determined desired scattered electric field into a plurality of component electric fields to be generated by the unit cells;
determining, based on the component electric fields, an impedance matrix; and
determining impedances of the unit cells such that each impedance in each unit cell is equal to a corresponding impedance in the impedance matrix.

2. The method of claim 1, further comprising:
decomposing the incident electric field into a plurality of spatial harmonics; and
determining the desired scattered electric field based on the plurality of spatial harmonics.

3. The method of claim 1, further comprising:
determining the plurality of desired currents using a method of moments calculation.

4. The method of claim 1, further comprising:
discretizing the antenna casing into a plurality of flat patches;
determining a mutual impedance matrix based on the flat patches; and
determining the plurality of impedances based on the determined mutual impedance matrix.

5. The method of claim 1, wherein discretizing the determined desired scattered electric field into a plurality of component electric fields comprises discretizing an integral of the determined desired scattered electric field into a matrix equation representing the plurality of component electric fields using a method of moments calculation.

6. The method of claim 1, wherein determining the desired scattered electric field to be created by the antenna casing further comprises:
decomposing the desired electric field into a plurality of spatial harmonics; and
synthesizing a desired far field pattern using Hankel functions that describe radially dependent terms of the plurality of spatial harmonics.

7. The method of claim 1, wherein determining the desired scattered electric field to be created by the antenna casing further comprises decomposing the desired scattered electric field into a plurality of modes of free space.

8. The method of claim 1, wherein determining the desired scattered electric field to be created by the antenna casing further comprises determining a plurality of Hankel functions based on the plurality of modes of free space.

9. A method for configuring unit cells of an antenna casing for an antenna based on a desired electric field for radiation, the method comprising:
receiving a desired incident electric field to be created by the antenna;
determining a desired scattered electric field to be created by the antenna casing, wherein the desired scattered field is equal to the desired incident electric field to be generated by the antenna minus the desired electric field;
determining, based on the determined desired scattered electric field, a plurality of desired currents for unit cells of the antenna casing;
discretizing, based on a geometry of the antenna casing and the plurality of desired currents, the determined desired scattered electric field into a plurality of component electric fields to be generated by the unit cells;
determining, based on the component electric fields, an impedance matrix; and
configuring impedances of the unit cells such that each impedance in each unit cell is equal to a corresponding impedance in the impedance matrix.

10. The method of claim 9, wherein discretizing the determined desired scattered electric field into a plurality of component electric fields comprises discretizing an integral of the determined desired scattered electric field into a matrix equation representing the plurality of component electric fields using a method of moments calculation.

11. The method of claim 9, wherein determining the desired scattered electric field to be created by the antenna casing further comprises:
decomposing the desired electric field into a plurality of spatial harmonics; and
synthesizing a desired far field pattern using Hankel functions that describe radially dependent terms of the plurality of spatial harmonics.

12. The method of claim 9, wherein determining the desired scattered electric field to be created by the antenna casing further comprises decomposing the desired scattered electric field into a plurality of modes of free space.

13. The method of claim 9, wherein determining the desired scattered electric field to be created by the antenna casing further comprises determining a plurality of Hankel functions based on the plurality of modes of free space.

14. A system, comprising:
an antenna configured to generate an incident electric field; and
an antenna casing, coupled to the antenna, configured to generate a scattered electric field, wherein the antenna casing comprises a plurality of unit cells, wherein each unit cell in the plurality of unit cells is configured to have a different impedance from other unit cells in the plurality of unit cells, and wherein the plurality of unit cells comprise:
a first unit cell, wherein the first unit cell is configured to have a first impedance when a first signal flows across the first unit cell at a first frequency, and
a second unit cell coupled to the first unit cell, wherein the second unit cell is configured to have a second impedance that is different from the first impedance when a second signal flows across the second unit cell at the first frequency, wherein the antenna casing is configured to alter, based on the first impedance and the second impedance, the incident electric field into a desired electric field, wherein the desired electric field is equal to the incident electric field plus a scattered electric field generated by the antenna casing based on geometry of the antenna casing, wherein the first impedance is configured to be equal to a first ratio of the desired electric field at the surface of the first unit cell to a first surface current of the first unit cell, and wherein the second impedance is configured to be equal to a second ratio of the desired electric field at the surface of the second unit cell to a second surface current of the second unit cell.

15. The system of claim 14, wherein the first impedance is a first ratio of the desired field at a first surface of the first unit cell to a first surface current of the first unit cell, and wherein the second impedance is a second ratio of the desired field at a second surface of the second unit cell to a second surface current of the second unit cell.

16. The system of claim 14, wherein the first unit cell comprises:
antenna casing material;
a capacitive metallic trace etched onto the antenna casing material; and
resistive material, wherein the first impedance is configured based on a resistance value of the resistive material and a capacitive value of the capacitive metallic trace.

17. The system of claim 16, wherein the capacitive metallic trace is a copper capacitive metallic trace.

18. The system of claim 16, wherein the resistive material is Nickel Phosphorous.

19. The system of claim 14, wherein the first unit cell comprises:
antenna casing material;
an inductive metallic trace etched onto the antenna casing material; and
resistive material, wherein the first impedance is configured based on a resistance value of the resistive material and an inductance value of the inductive metallic trace.

20. The system of claim 14, wherein the plurality of unit cells are oriented in a direction of an electric field vector of the incident electric field.
